(19) United States
(12) Patent Application Publication
(10) Pub. No.: US 2024/0346027 A1
(43) Pub. Date: Oct. 17, 2024

(54) Data Generation Based on Data Stored in Relational Databases

(71) Applicant: Nirvaha Corporation, Bellevue, WA (US)

(72) Inventor: Ramesh Parameswaran, Bellevue, WA (US)

(21) Appl. No.: 18/135,009

(22) Filed: Apr. 14, 2023

(51) Int. Cl. G06F 16/2457; G06F 16/242; G06F 16/2455

(52) U.S. Cl. CPC G06F 16/24575; G06F 16/2425; G06F 16/2456

(57) ABSTRACT

A system generates data based on a database system, for example, a production database system. The system receives a data bias specification describing characteristics of the data being generated. The system identifies paths of database tables from the database system and executes database queries that join tables in the path. The system determines an initial path to generate a set of records. The system adds additional records to the set of records by identifying new paths and executing queries that join the tables of the new paths. The new paths include tables that were previously processed and create new versions of data for these tables. The database queries are generated so that the extracted data conforms to the data bias specification. The system uses the extracted dataset as training data for generating data.

### TECHNICAL FIELD

This disclosure relates generally to database systems, and more specifically to generation of data based on data stored in a database system.

### BACKGROUND

Developers often need large amount of data, for example, for training machine learning models. Often it is difficult to obtain large amount of training data based on real world sources. The desired amount of data may not be available or accessible to developers. Often real-world data may include sensitive information leading to privacy issues. Systems may generate data that is computer generated and not obtained from real-world sources. However, computer generated data may not reflect the real-world data. For example, there is need for data that mirrors data stored in database systems, for example, relational database management systems (RDBMS). The data stored in a relational database management system often has several constraints. These include primary key/foreign key constraints, check constraints, unique constraint, not null constraint, and so on. If data is randomly generated, it may not satisfy the necessary constraints. Furthermore, real-world data may have specific data patterns, for example, specific columns of a database table may have particular statistics. Randomly generated data may not have similar statistics making it less useful for purposes such as training of machine learning models.

### SUMMARY

A system generates data based on a source database system, for example, a production database system. The source database system has a schema comprising database tables and relationships between database tables. The system receives a data bias specification describing characteristics of the data being generated. The data bias specification based on a database table of the source database system. The system determines a target size of an extracted dataset configured to store data extracted from the source database system.

The system initializes a result size parameter. The system repeats the following steps one or more times. The system initializes the extracted dataset to a set of records selected from a subset of database tables of the source database system. The set of records is selected based on the data bias specification. The size of the set of records is determined based on the result size parameter. The system updates the extracted dataset, based on additional constraints based on relationships between other database tables of the schema of the database. The system determines whether the size of the extracted dataset is below the target size. If the system determines that the size of the extracted dataset is below the target size, the system increases the result size parameter and repeats the above steps until; the size of the extracted dataset reaches or exceeds the target size.

According to an embodiment, the system extracts data from the source database system as follows. The system identifies an initial path of database tables from the database system. The initial path starts from a database table with no incoming relationships. The initial path may end in a database table that has no outgoing relationships. The initial path may also represent a cycle of relationships. Each database table in the initial path has either an incoming relationship or an outgoing relationship or both. The system executes an initial database query that joins database tables of the initial path. The system stores results of the initial database query in an extracted data set. The extracted data set has a partial schema that is a subset of the schema of the database system.

The system repeats the following steps until all database tables of the database system are processed. The system identifies a new path of database tables from the schema of the database system. The system updates the extracted data set based on constraints determined based on the tables of the new path. The system may execute a new database query that joins the database tables of the new path to update the extracted dataset. The new database query uses the data generated so far for the database table from the path previously processed. Once all database tables of the database system are processed, the system generates additional data based on the extracted data set. The additional data may be obtained by performing data generation.

The techniques disclosed may be implemented as computer implemented methods. The techniques may be implemented as program code (or software or instructions) stored on a non-transitory computer readable storage medium and executable by one or more computer processors. In addition, the method also may be embodied as a computer system comprising functional modules that may be structured to include program code and execute through one or more computer processors, controller, field programmable gate array (FPGA), or application specific integrated circuit (ASIC).

### BRIEF DESCRIPTION OF THE DRAWINGS

FIG. 1 is a system environment for a data generation system, in accordance with an embodiment.

FIG. 2 shows a system architecture of a data generation system, according to an embodiment.

FIG. 3 shows an example schema of a database system that may be used for generating data, according to an embodiment.

FIG. 4 shows a flowchart of a process 400 for generating data based on data stored in a source database system according to an embodiment.

FIG. 5 shows a flowchart of a process 500 for extracting a subset of data from a source database system according to an embodiment.

FIG. 6A illustrates the steps of the process for extraction of data from a schema in accordance with an embodiment.

FIG. 6B illustrates additional steps of the process for extraction of data from a schema in accordance with an embodiment.

FIG. 7 is a high-level block diagram illustrating a functional view of a typical computer system for use as one of the entities illustrated in the environment of FIG. 1 according to an embodiment.

The figures depict various embodiments for purposes of illustration only. One skilled in the art will readily recognize from the following discussion that alternative embodiments of the structures and methods illustrated herein may be employed without departing from the principles described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

Embodiments generate data based on data stored in a source database system, for example, a production database system. The system generates data based on the source database system that has a schema matching the schema of the source database system. Furthermore, the generated data as characteristics matching the data of the source database system, for example, the generated data has statistical distribution that is similar to the statistical distribution of data stored in the source database system. As an example, if the source database system has a particular keyword k1 that occurs in a column col1 of a table in n % of records of a table T1, the generated data also has similar distribution so that the keyword k1 occurs in column col1 of a table corresponding to table T1 in the generated data.

According to an embodiment, the system allows users to provide a data bias specification that describes expected characteristics of the generated data. The data bias specification may describe specific characteristics using columns of tables of the source database system. For example, the data bias specification may specify that the generated data should be based on the most popular entities represented by records in a particular table, or the generated data should be based on users of a particular geographical region, or the generated data should be based on transactions that occurred within a particular time range, and so on. Data generation may also be referred herein as synthetic data generation.

The system generates database queries that incorporate the input provided by the user in the data bias specification. The system extracts a data set based on the source database system that has a data bias as specified in the data bias specification. The extracted data is used as training data for further generation of additional data, for example, using synthetic data generation.

The data bias specification may specify that a particular statistic of the database table in the extracted dataset should be within a threshold of the particular statistic of a corresponding database table in the source database system. The data bias specification may specify the target statistics of the extracted dataset in terms of a column of a database table of the source database system. Examples of statistics specified in the data bias specification includes a frequency, a standard deviation, or a histogram based on data stored in one or more columns of a database table.

Typically, production database store very large amount of data, for example, several terabytes of data. Therefore, using the full production database as training data for a model that generates data is not feasible. Embodiments allow generation of data based on a production data by extracting a dataset that is a subset of the data of the production database but has the desired characteristics of the production data as well as characteristics specified using a data bias specification. Accordingly, the embodiments improve the performance of the data generation as well as allow customization of the characteristics of the data generated.

### System Environment

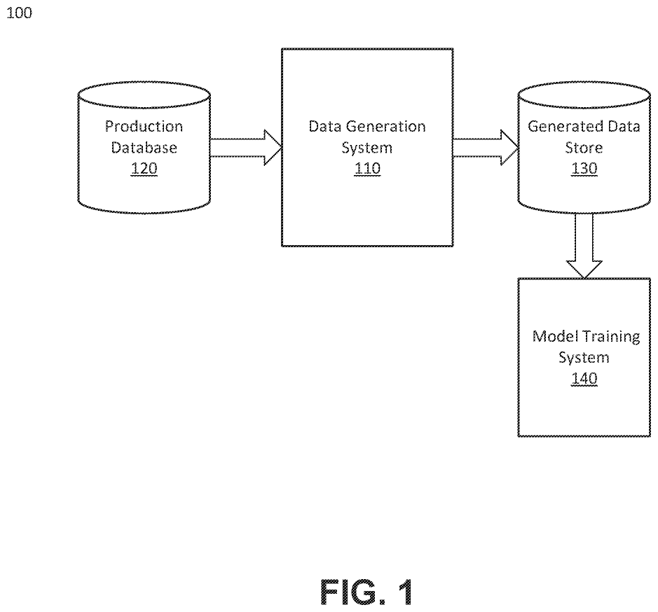

FIG. 1 is a system environment for a data generation system, in accordance with an embodiment. The system environment 100 comprises a production database 120, a generated data store 130, a data generation system 110, and a model training system 140. The various components are configured to communicate over a network. In alternative configurations, different and/or additional components may be included in the system environment 100.

The production database 120 may be part of a production database system that processes user requests that modify the data stored in the production database 120. According to an embodiment, the production database is a relational database. Accordingly, the production database system may be a relational database management system (RDBMS), such as SQL server, ORACLE, DB2, and so on. As noted above, although described primarily herein with reference to SQL server, the system and methods described herein may be utilized with other database servers.

The data generation system 110 generates data based on the data stored in the production database and stores the generated data in the generated data store 130. The data generated by the data generation system 110 is structured data that matches the schema of the production database. According to an embodiment, the data generation system 110 receives from a user, a data bias specification that describes specifies characteristics of the data that needs to be generated, for example, specific bias that is needed in the generated data. The data generation system 110 generates data based on the data stored in the production database 120 that conforms to any data bias specification specified by the user. The generated data store 130 stores the data generated by the data generation system 110 based on the production database.

The generated data may be used for various purposes. For example, the model training system 140 uses the data generated by the data generation system 110 and stored in the generated data store 130 as training data for training machine learning models. The generated data may be used for other purposes for example, for testing purposes.

Users may interact with the components of the system environment 100 using client devices (also referred to as user devices). For example, a client device may be used for providing data bias specification. A client device may be used for inspecting the progress of the data being generated.

The client devices are one or more computing devices capable of receiving user input as well as transmitting and/or receiving data via a network. In one embodiment, a client device is a conventional computer system, such as a desktop or a laptop computer. Alternatively, a client device may be a device having computer functionality, such as a mobile telephone, a smartphone, or another suitable device. A client device is configured to communicate via the network to retrieve, create, or modify information in the production database. In one embodiment, a client device executes an application allowing a user of the client device to interact with the components of the system environment 100. For example, a client device may execute a browser application to enable interaction between the client device and the data generation system via the network.

The client devices are configured to communicate via the network, which may comprise any combination of local area and/or wide area networks, using both wired and/or wireless communication systems. In one embodiment, the network uses standard communications technologies and/or protocols. For example, the network includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network may be encrypted using any suitable technique or techniques.

### System Architecture

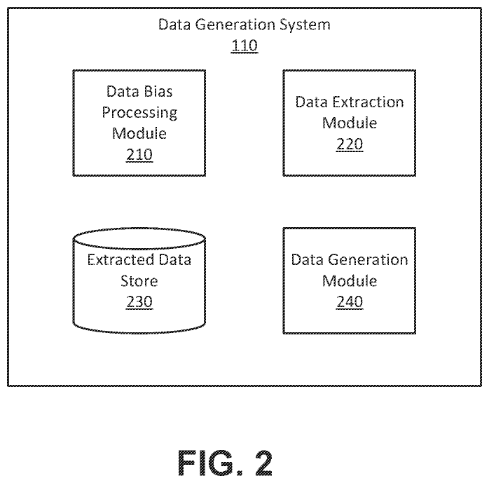

FIG. 2 shows a system architecture of a data generation system, according to an embodiment. The data generation system 110 includes a data bias processing module 210, a data extraction module 220, an extracted data store 230, and a data generation module 240. Other embodiments may include more or fewer modules than those indicated in FIG. 2. Functionality indicated herein as being performed by a particular module may be performed by modules other than those indicated herein.

The data bias processing module 210 receives a data bias specification from the user. The data bias specification describes the type of data that the user is interested in generating. According to an embodiment, the data bias specification is an expression based on columns of one or more tables of the database system. For example, the data bias specification may specify that the generated data should have the same data distribution as the database tables of the database system. The data bias specification may specify that the generated data should have the same data distribution as a subset of the database tables of the database system, for example, the system should make sure that the data distribution of a particular table in the generated data matches the data distribution of the particular table in the database system. The data distribution may be compared using histograms of the database tables so that the particular table in the generated data has a histogram with value within a threshold of a histogram of the particular database table in the database system.

The data bias specification may specify that have a particular distribution that may be different from the distribution of the database system. For example, the data bias specification may specify that generated data should have at least a threshold percentage of records that satisfy a particular user specified constraint. The data bias specification may be an expression based on columns of database tables. The data bias specification may be based on a particular column of a database, for example, col1>M1 where col1 is a column and M1 is a constant value; or col1=M1. The data bias specification may be based on multiple columns each column selected from a database table, for example, (col1>M1 and col2>M2) where col1 and col2 are columns and M1 and M2 are constant values. For example, the user specified constraint may specify that the generated data should include at least 30% records where state is “California”. As another example, the user specified constraint may specify that the generated data should include at least 20% records where employee table has an age column that is in a range 20-40. The user specified constraint may specify conditions based on multiple columns, for example, the user specified constraint may specify that the generated data should include at least 50% records where state column is California and user has more than K transactions in a transactions table, where K is a constant.

According to an embodiment, the system supports a syntax for allowing users to specify data bias specification. The syntax allows users to specify data bias specification using expressions based on columns of tables of the database system. The system parses the syntax of the data bias specification to generate data structures representing the data bias specification. The data structure is used for subsequent processing, for example, to generate database queries that extract data conforming to the data bias specification from a production database. Clients may provide data bias specification using APIs (application programing interfaces).

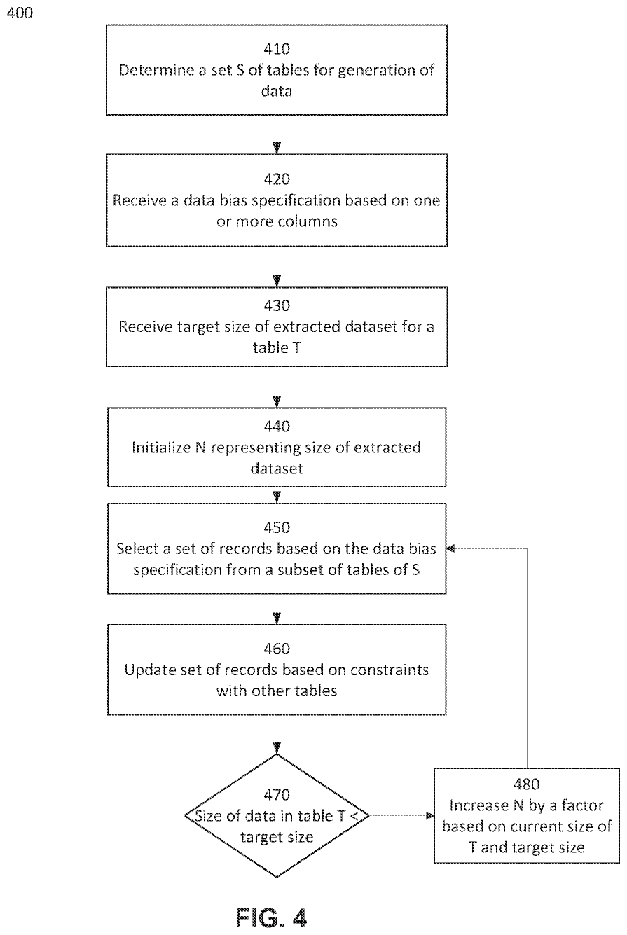

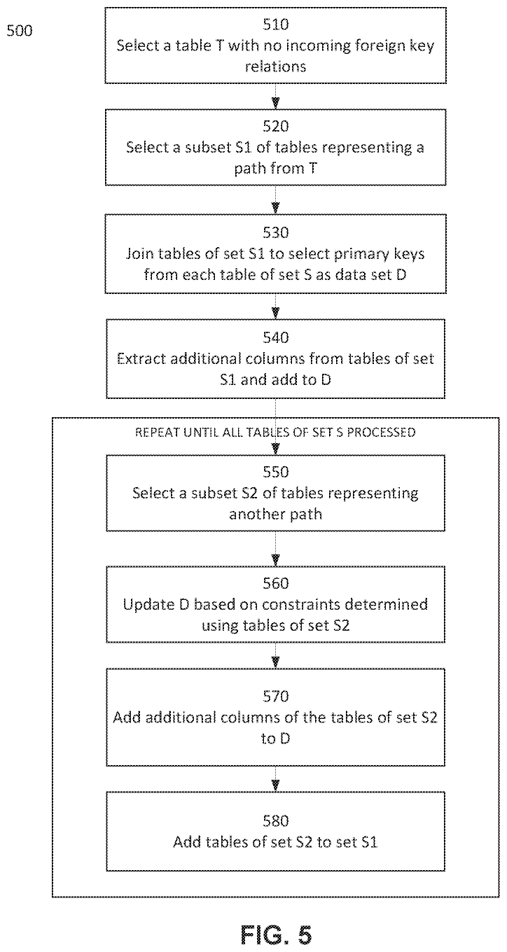

The data extraction module 220 executes processes described herein to extract data from the database system to store a subset of data in the extracted data store 230. The details of these processes are further illustrated herein, for example, in FIGS. 4 and 5 and described in connection with FIGS. 4 and 5 as well as other figures.

The data generation module 240 generates additional data based on the data stored in the extracted data store 230. The data generated module 240 uses the data stored in the extracted data store as training data for generating additional data. The additional data generated is also referred to as synthetic data since it is automatically generated. The additional data is generated to have the same schema as the data stored in the extracted data store as well as matching characteristics.

The data generation module 240 may use machine learning models for generating additional data using the extracted dataset as training data. The data generation module 240 may use techniques such as predictive modelling or generative modeling to generate data that has characteristics matching the training dataset used for generating additional data. Since the system generates extracted dataset based on a source database system and data bias specification, the additional data generated by the data generation module 240 has characteristics of the extracted data set. The system may generate an extracted dataset that has characteristics that are distinct from the source database system, for example, based on the data bias specification. Accordingly, the characteristics of the data generated by the data generation module 240 can be modified compared to the source database system by using the data bias specification. The data generation module 240 may use existing systems or techniques for data generation.

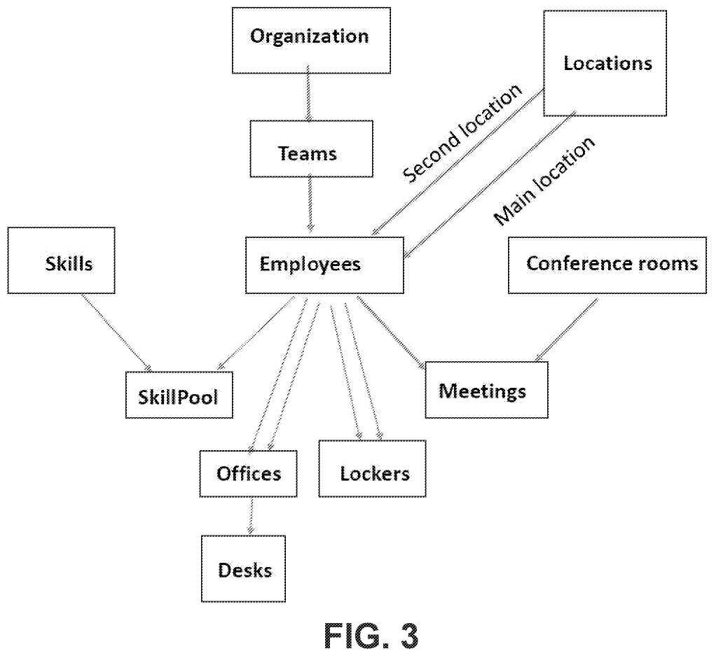

FIG. 3 shows an example schema of a database system that may be used for generating data, according to an embodiment. The schema includes several tables, for example, skills table, skillpool table, organization table, teams table, employees table, offices table, desks table, lockers tables, locations table conference_rooms table, meetings table, and so on. The schema includes relationships between tables. The relationships are based on foreign keys defined in the database system. For example, if there is a foreign key in table T1 based on a primary key of table T2, there is a relationship from table T1 to T2. Accordingly, the schema may be represented using a graph comprising nodes and edges where nodes correspond to tables and edges correspond to relationships. According to an embodiment, the edges of the graph are directed edges. For example, if table T1 has a foreign key based on a primary key of table T2, the table T1 has an edge going to table T2. The graph formed by the schema of the database system has paths formed by tracing tables through relationships. For example, the graph shown in FIG. 3 has a path formed by skills table and skillpool table; another path formed by organization table, team table, employees table, and skillpool table; another path formed by locations table, employees table, and meetings table, and so on.

A user may specify different types of data bias specification to describe the characteristics of the data being generated. The data bias specification may specify that the generated data should include at least a threshold records that include skills belonging to a set of skill, for example, by specifying a constraint based on a column from skills table. The threshold of records may be specified as a percentage of records generated, for example, 30% of records of a table included in the extracted dataset should have values as specified. As another example, the data bias specification may specify that the generated data should include at least a threshold records that have locations belonging to a set of locations, for example, by specifying a constraint based on a column from locations table. The data bias specification may be based on multiple columns, for example, the data bias specification may specify that the generated data should include at least a threshold records that have locations belonging to a set of locations and employees having a particular characteristic (e.g., a particular age range or particular skills). Such a data bias specification may be specified using constraints columns from locations table, employees table, and skills table.

### Process of Extracting a Subset of Data

FIG. 4 shows a flowchart of a process 400 for generating data based on data stored in a source database system according to an embodiment. The described operations may be performed by modules of the data generation system 110, for example, the data extraction module 220 and other modules. Embodiments may include different and/or additional steps or perform the steps in different orders.

The system determines 410 a set of tables of a source database system for generation of data. The set of tables ay be specified by a user. The user identifies a database system for use in generation of the data. By default, the system uses the entire schema of the source database system specified by the user. However, a user may specify a set of tables representing a subset of tables of the source database system.

The system receives 420 a user bias specification describing expected characteristics of the data being generated. The user bias specification may be an expression based on one or more columns of tables of the source database system.

The system receives 430 an estimate of a size of the extracted dataset. The system generates an extracted dataset based on the specified estimate of size. According to an embodiment, the estimate of the size M may be specified as the number of records of a particular table T. Accordingly, the system generates the extracted data set that has at least the specified number M of records in the table T.

The system initializes a parameter N that represents a size of the extracted data set. According to an embodiment, the system may initialize the parameter N to the value of S specified by the user. The system executes one or more database queries to select 450 a set of records from the source database system. The set of records initially extracted may not include the table T. The system incorporates the data bias specification in the database queries. The system may add filters to the database queries so that the extracted data conforms to the data bias specification. For example, of the data bias specification specifies that the extracted data set should include records that have a value V1 for column coli of table T1, the system may add a filter “col1=V1” to one or more database queries that process the table T1. The system extracts a set of records from a subset of tables of the schema. The system executes additional database queries to add 460 records from remaining tables of the schema. The additional database queries ensure that the relationships between the tables are considered while extracting additional records. For example, if a record R of table T1 was previously extracted and included in the extracted dataset and table T1 has a foreign key to a table T2, a subsequent query may update the extracted dataset based on a foreign key constraint based on table T2. The update to the extracted dataset may reduce the number of records of the extracted dataset as additional constraints are processed. The system performs an iterative process illustrated in FIG. 5 that collects records from various tables.

Once the system has processed all the tables of the set S of tables specified by the user, the system checks the size of the table T in the extracted set. If the size of the table T is determined 470 to be less than the specified size M, the system increases the parameter N and repeats the process with the increased size N.

According to an embodiment, the system increases the value of the parameter N by a scaling factor. The scaling factor may be determined based on a number of records of the table T in the extracted data set compared to the target size. For example, the scaling factor may be based on a ratio of the target size M to the number of records of the table T in the extracted data set. If the size of the table T in the extracted dataset is a fraction P of the target size M, the value of the parameter N is scaled by a factor inversely proportionate to P. For example, the extracted dataset is half of the target size M, the value of the parameter N is scaled by a factor of two. The above process of extracting the dataset is repeated with the increased parameter P. The size of the table T is determined in the extracted dataset obtained from the increased parameter P. If the size of the table T is at least the specified target size M, the iterations are stopped and the extracted dataset used for the next step, or else the iterations continued.

FIG. 5 shows a flowchart of a process 500 for extracting a subset of data from a source database system according to an embodiment. The described operations may be performed by modules of the data generation system 110, for example, the data extraction module 220 and other modules. Embodiments may include different and/or additional steps or perform the steps in different orders.

The process illustrated in FIG. 5 represents details of the steps 450 and 460 of the process shown in FIG. 4. The system identifies an initial path P1 of database tables from the database system. The initial path starts from a database table with no incoming relationships. In a graph representation of the schema, the initial path P1 starts from a node with no incoming edges. Accordingly, the system selects 510 a table T1 with no incoming relationships and selects 520 a subset S1 of tables of the schema of the source database system. The set S1 represents a path starting at the table T1. Each database table in the initial path has either an incoming relationship or an outgoing relationship or both.

According to an embodiment, the initial path is selected based on the data bias specification. For example, if the data bias specification specifies characteristics of the generated data in terms of columns of table Tx, the system selects initial path that includes table Tx.

The system generates an initial database query Q1 that joins the tables of the set S1 based on the foreign key relationships between the tables of the set S1. The system executes the initial database query Q1 to join 530 the database tables of the initial path. The result of execution of the database query Q1 is referred to as R1. According to an embodiment, the system selects the primary keys of each table of the path P1 in the initial database query. The system subsequently executes one or more join queries to join 540 the result R1 of the database query Q1 with individual tables of the set S1 to extract additional columns of each table. Splitting the process of extraction of data into smaller queries improves the performance of execution. For example, if the system executed a complex query that joins all tables of the source database, the system may not be able to optimize the complex query and the execution performance of the complex query may be very slow.

The system stores the results R1 of the initial database query Q1 in an extracted data set. The extracted data set may be stored in the extracted data store 230 that has a partial schema that is a subset of the schema of the database system.

The system repeats the following steps 550, 560, 570, 580 until all database tables of the database system are processed. The system selects 550 a subset S2 of tables representing a new path of database tables from the schema of the database system. The new path P2 includes at least a database table from a path previously processed, i.e., a database table of the partial schema of the extracted dataset. The system generates a new database query Q2 that joins the database tables of the new path P2. The new database query Q2 uses the data extracted so far for any database table of the partial schema of the extracted dataset, i.e., any database table from the paths previously processed. For database tables of the new path P2 that are not included in the partial schema of the extracted data set, the system uses the data of the source database system. According to an embodiment, the system executes the database query Q2 to join 560 tables of the path P2 with the extracted dataset. The query Q2 ensures that the records in the extracted data set further include data in the tables of the new path P2. The database query Q2 may further extract primary keys of tables of the path P2 and add them to the extracted dataset. Since the query Q2 incorporates additional constraints based on the path P2, the execution of the query may result in reducing the number of records of the extracted dataset. The system may execute additional queries that join 570 the extracted dataset to individual tables of path P2 to extract additional columns of the table of the path P2. This process is repeated until all database tables of the set S received as input are processed. The system further generates additional data, for example, synthetic data based on the extracted data set.

The process of extraction of data based on a schema of a source database system is illustrated via examples based on the schema shown in FIG. 3. Accordingly, the following examples assume that the system receives a request to generated data based on a production database having schema illustrated in FIGS. 3.

According to an embodiment, the system determines the different paths through the graph represented by the schema of the database system by performing a graph traversal, for example, depth first search graph traversal. The system performs depth first search by selecting a root node (i.e., a node with no incoming edges) and exploring as far as possible along each branch before backtracking. According to an embodiment, the system selects paths that start at a root node and ends at one or more leaf nodes.

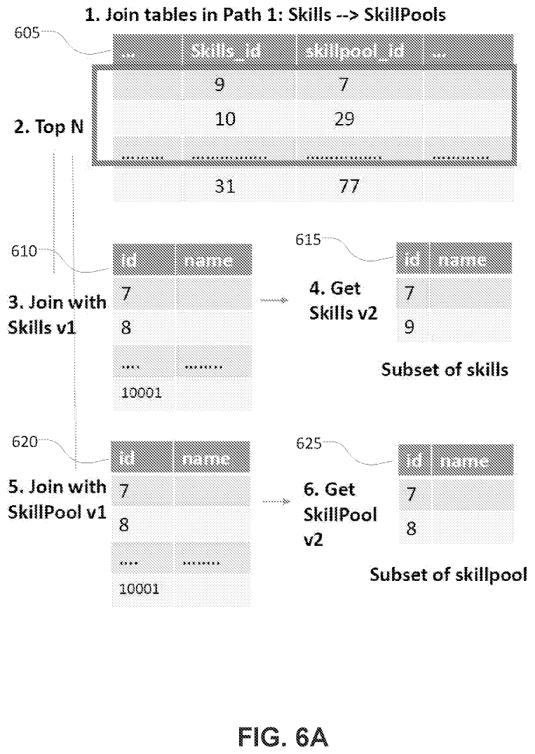

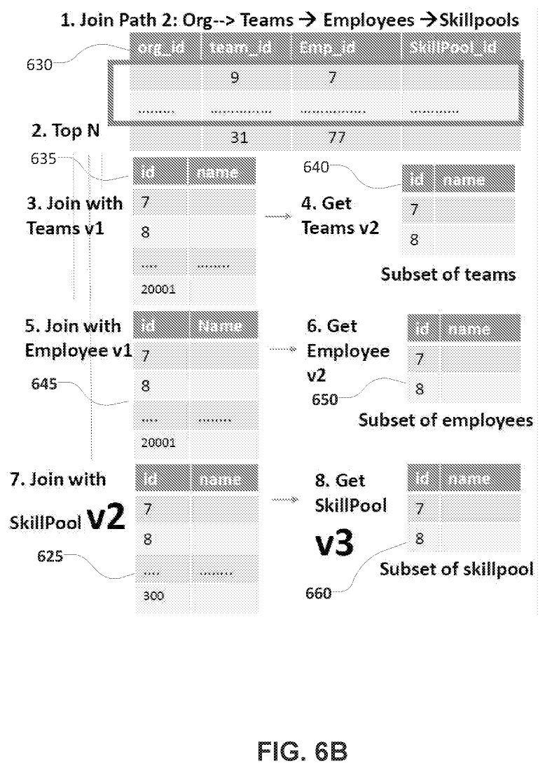

FIG. 6A illustrates the steps of the process for extraction of data from a schema in accordance with an embodiment. The system identifies an initial path in the graph represented by the schema shown in FIG. 3. In particular, the system identifies the path including the skills table and the skillpool table. In this path the skills table has no incoming relationships and the skillpool table has no outgoing relationships. As shown in FIG. 6A, the system first executes an initial database query that joins the tables of the initial path, i.e., skills table with the skillpool table to extract the primary keys skills_id and skillpool_id respectively into the results table 605. The system selects the top N records of the result of the join query. The value of N may be specified by the user. Alternatively, the user specifies a parameter M that indicates the size of the extracted data and the system determines the value of N based on parameter M. The results are ordered based on the data bias specification to obtain records that conform to the data bias specification.

The system joins the results table 605 with the skills table 610 to extract columns of the skills table. The input skills table represents version v1 of the skills table and the input skillpool table represents version V1 of the skillpool table. Accordingly, the system generates the version V2 of the skills table 615 by joining the results table 605 with the version v1 of the skills table 610. The version V2 of the skills table is a subset of the version V1 of the skills table. Similarly, the system generates the version V2 of the skillpool table 625 by joining the results table 605 with the version V1 of the skillpool table 620. The version V2 of the skillpool table is a subset of the version V1 of the skillpool table. The partial schema of the result extracted so far includes only two tables, skills table and skillpool table.

Accordingly, the system may generate multiple versions of each database table. The version number of a database table that is included in the extracted dataset depends on the number of times the table is included in a new path that is processed by the system. When a version Vn of a table is processed in connection with a new path, the version Vn of the database table in extracted dataset is replaced by the next version Vn+1 of that database table.

FIG. 6B illustrates additional steps of the process for extraction of data from a schema in accordance with an embodiment. The system identifies a second path that includes at least one table from the partial schema. The second path comprises the organization table, teams table, employees table, and the skillpool table. The skillpool table is the table from the partial schema that is included in the second path. The system executes a join query to extract all the primary keys of the tables of the second path. The result of execution of this join query is the results table 630 that includes the primary key column org_id from organization table, the primary key column team_id from the teams table, the primary key column emp_id from the employees table, and the primary key column skillpool_id from the skillpool table. The new query orders the results according to the data bias specification and selects the top N records of the result of the join operation. The system joins the results table 630 with the latest version of the table in the second path. Accordingly, the system joins the results table 630 with the version v1 of the teams table 635 to obtains the version v2 of the teams table 640 that includes a subset of the records of the version v1 of the teams table. The system joins the results table 630 with the version v1 of the employees table 645 to obtains the version v2 of the employees table 650 that includes a subset of the records of the version v1 of the employees table. The system joins the results table 630 with the version v2 of the skillpool table 625 to obtains the version v3 of the teams table 660 that includes a subset of the records of the version v2 of the skillpool table 625. The system adds the tables of the second path to the partial schema of the extracted dataset.

Accordingly, this process continues. The system identifies a new path and joins the tables of the path. The system determines a result by selecting a subset of the records ordered based on the data bias specification. The system joins the result table to the latest version of the individual tables of the path. The system adds the tables of the path to the partial schema.

### Computer Architecture

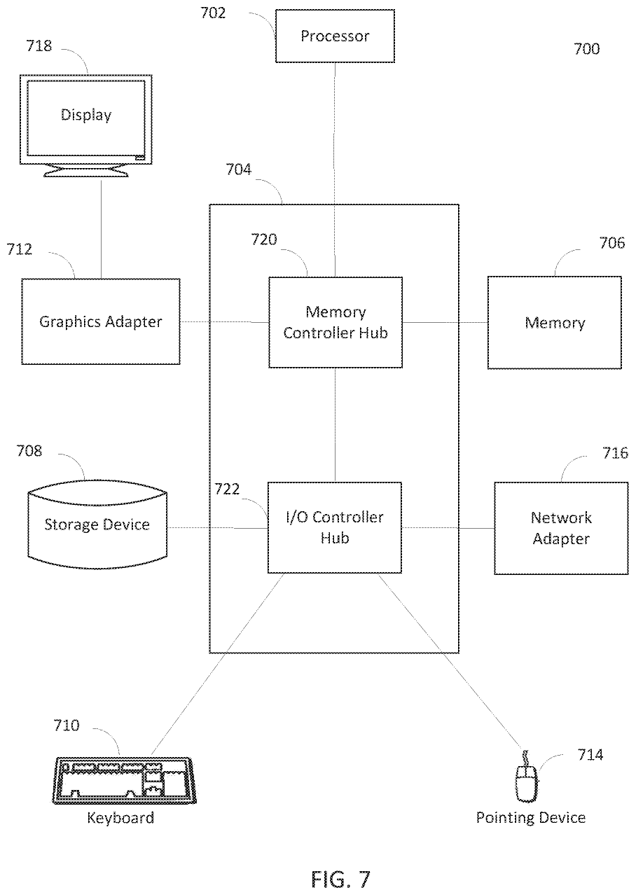

FIG. 7 is a high-level block diagram illustrating a functional view of a typical computer (or computer system) for use as one of the entities illustrated in the environment 100 of FIG. 1 according to an embodiment. Illustrated are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is a non-transitory computer-readable storage medium, such as a hard drive, compact disk read-only memory (CD-ROM), DVD, or a solid-state memory device. The memory 706 holds instructions and data used by the processor 702. The pointing device 714 may be a mouse, track ball, or other type of pointing device, and is used in combination with the keyboard 710 to input data into the computer system 200. The graphics adapter 712 displays images and other information on the display 718. The network adapter 716 couples the computer 700 to a network.

As is known in the art, a computer 700 can have different and/or other components than those shown in FIG. 7. In addition, the computer 700 can lack certain illustrated components. For example, a computer system 700 acting as a data generation system 110 may lack a keyboard 710 and a pointing device 714. Moreover, the storage device 708 can be local and/or remote from the computer 700 (such as embodied within a storage area network (SAN)).

The computer 700 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 708, loaded into the memory 706, and executed by the processor 702.

The types of computers 700 used by the entities of FIG. 1 can vary depending upon the embodiment and the processing power used by the entity. For example, a client device 104 may be a mobile phone with limited processing power, a small display 718, and may lack a pointing device 714. The database system in contrast, may comprise multiple servers working together to provide the functionality described herein.

### Additional Considerations

The described systems and methods allow users to access current production data without restoring a full backup. In contrast to restoring a full backup, which may take several hours, the system may deliver cloned differencing disks with current production data to users in a matter of seconds. Thus, users may quickly access current production data without waiting hours for a full backup.

Additionally, the described system and methods decrease the length of differencing disk chains while supporting previously delivered clones to users. Long VHD chains are known to reduce read/write performance. Conventional VHD use involves frequent merge operations to decrease the length of differencing disk chains. However, with conventional merging operations, the ability to support clones from the merged differencing disks is lost. The described system provides a replicated differencing disk chain that includes an active chain and an inactive chain. By merging differencing disks on the inactive chain without simultaneously merging the differencing disks on the active chain, the recently created clones from the differencing disks on the active chain continue to be supported. Thus, users may continue to use recently created clones to access production data.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A computer-implemented method for generating data, the computer-implemented method comprising:
receiving a request from a user via network to generate data based on data stored in a database system, the database system having a schema comprising database tables and relationships between database tables;
identifying, by one or more computer processors, an initial path of database tables from the database system, the initial path starting from a database table with no incoming relationships, wherein each database table in the initial path has one or more of: an incoming relationship or an outgoing relationship;
executing, by the one or more computer processors, an initial database query that joins database tables of the initial path to extract predetermined number of records of each table of the database tables;
storing results of the initial database query in an extracted data set, the extracted data set having a partial schema that is a subset of the schema of the database system;
repeating, by the one or more computer processors, until all paths of database tables of the database system are processed:
identifying a new path of database tables from the schema of the database system;
executing a new database query that joins the database tables of the new path, the new database query using the data generated so far for the database table from the path previously processed; and
updating the extracted data set with the generated data based on the new database query from the new path; and
responsive to processing all the database tables, determining whether a table in the extracted data set meets a target size defined by the user;
responsive to determining that the table in the extracted data set fails to meet the target size, modifying the initial database query to extract the predetermined number of records;
automatically generating, by the one or more computer processors, additional data based on data stored in the extracted data set as training data.

2. The computer-implemented method of claim 1, wherein a first database table has a relationship to a second database table if the first database table has a foreign key based on the second database table.

3. The computer-implemented method of claim 1, wherein the initial path ends in a database table with no outgoing relationships.

4. The computer-implemented method of claim 1, wherein the new database query extracts keys from the database tables of the new path, the computer-implemented method further comprising:
joining results of the new database query to a table from the new path to extract one or more additional columns of the table from the new path.

5. The computer-implemented method of claim 1, further comprising:
receiving data bias specification for the data being generated, the data bias specification describing a characteristic of the data being generated, wherein the additional data generated conforms to the data bias specification.

6. The computer-implemented method of claim 5, wherein the data bias specification describes statistics of the extracted data set in terms of one or more columns of the database system.

7. (canceled)

8. The computer-implemented method of claim 1, wherein the predetermined number of records is increased by a factor based on a number of records of the table in the extracted data set compared to the target size.

9. A non-transitory computer readable storage medium comprising stored instructions, the instructions when executed cause one or more computer processors to:
receive a request from a user via network to generate data based on data stored in a database system, the database system having a schema comprising database tables and relationships between database tables;
identify, by the one or more computer processors, an initial path of database tables from the database system, the initial path starting from a database table with no incoming relationships, wherein each database table in the initial path has one or more of: an incoming relationship or an outgoing relationship;
execute, by the one or more computer processors, an initial database query that joins database tables of the initial path to extract predetermined number of records of each table of the database tables;
store results of the initial database query in an extracted data set, the extracted data set having a partial schema that is a subset of the schema of the database system;
repeat, by the one or more computer processors, until all paths of database tables of the database system are processed:
identify a new path of database tables from the schema of the database system;
execute a new database query that joins the database tables of the new path, the new database query using the data generated so far for the database table from the path previously processed; and
update the extracted data set with the generated data based on the new database query from the new path; and
responsive to processing all the database tables, determine whether a table in the extracted data set meets a target size defined by the user;
responsive to determining that the table in the extracted data set fails to meet the target size, modify the initial database query to extract the predetermined number of records;
automatically generate, by the one or more computer processors, additional data based on data stored in the extracted data set as training data.

10. The non-transitory computer readable storage medium of claim 9, wherein a first database table has a relationship to a second database table if the first database table has a foreign key based on the second database table.

11. The non-transitory computer readable storage medium of claim 9, wherein the initial path ends in a database table with no outgoing relationships.

12. The non-transitory computer readable storage medium of claim 9, wherein the new database query extracts keys from the database tables of the new path, wherein the instructions further cause the one or more computer processors to:
join results of the new database query to a table from the new path to extract one or more additional columns of the table from the new path.

13. The non-transitory computer readable storage medium of claim 9, wherein the instructions further cause the one or more computer processors to: receive data bias specification for the data being generated, the data bias specification
describing a characteristic of the data being generated, wherein the additional data generated conforms to the data bias specification.

14. The non-transitory computer readable storage medium of claim 13, wherein the data bias specification describes statistics of the extracted data set in terms of one or more columns of the database system.

15. (canceled)

16. The non-transitory computer readable storage medium of claim 13, wherein the predetermined number of records is increased by a factor based on a number of records of the table in the extracted data set compared to the target size.

17. A computer system comprising:
one or more computer processors; and
a non-transitory computer readable storage medium comprising stored instructions, the instructions when executed cause the one or more computer processors to:
receive a request from a user via network to generate data based on data stored in a database system, the database system having a schema comprising database tables and relationships between database tables;
identify, by the one or more computer processors, an initial path of database tables from the database system, the initial path starting from a database table with no incoming relationships, wherein each database table in the initial path has one or more of: an incoming relationship or an outgoing relationship;
execute, by the one or more computer processors, an initial database query that joins database tables of the initial path to extract predetermined number of records of each table of the database tables;
store results of the initial database query in an extracted data set, the extracted data set having a partial schema that is a subset of the schema of the database system;
repeat, by the one or more computer processors, until all paths of database tables of the database system are processed:
identify a new path of database tables from the schema of the database system;
execute a new database query that joins the database tables of the new path, the new database query using the data generated so far for the database table from the path previously processed; and
update the extracted data set with the generated data based on the new database query from the new path; and
responsive to processing all the database tables, determine whether a table in the extracted data set meets a target size defined by the user;
responsive to determining that the table in the extracted data set fails to meet the target size, modify the initial database query to extract the predetermined number of records;
automatically generate, by the one or more computer processors, additional data based on data stored in the extracted data set as training data.

18. The computer system of claim 17, wherein the new database query extracts keys from the database tables of the new path, wherein the instructions further cause the one or more computer processors to:
join results of the new database query to a table from the new path to extract one or more additional columns of the table from the new path.

19. The computer system of claim 17, wherein the instructions further cause the one or more computer processors to:
receive data bias specification for the data being generated, the data bias specification describing a characteristic of the data being generated, wherein the additional data generated conforms to the data bias specification.

20. (canceled)

21. The computer system of claim 17, wherein the instructions further cause the one or more computer processors to:
receive data bias specification for the data being generated, the data bias specification describing a characteristic of the data being generated, wherein the additional data generated conforms to the data bias specification.

22. The computer system of claim 21, wherein the data bias specification describes statistics of the extracted data set in terms of one or more columns of the database system.
